(19) United States
(12) Patent Application Publication
(10) Pub. No.: US 2005/0148547 A1
(43) Pub. Date: Jul. 7, 2005

(54) Fungicidal mixtures based on benzamidoxime derivatives and azoles

(76) Inventors: Eberhard Ammermann, Heppenheim (DE); Reinhard Stierl, Freinsheim (DE); Gisela Lorenz, Neustadt (DE); Siegfried Strathmann, Limburgerhof (DE); Klaus Schelberger, Gonnheim (DE); Maria Scherer, Godramstein (DE); Egon Haden, Kleinniedesheim (DE)

Correspondence Address: Keil & Weinkauf, 1350 Connecticut Avenue NW, Washington, DC, 20036, US

(21) Appl. No.: 10/509,797

(22) PCT Filed: Apr. 2, 2003
(86) PCT No.: PCT/EP03/03432

(30) Foreign Application Priority Data
Apr. 5, 2002 (DE) 10215145.8

(51) Int. Cl. A01N 55/00; A01N 43/64; A01N 43/50

(52) U.S. Cl. 514/63; 514/383; 514/617; 514/396; 514/384

(57) ABSTRACT

Fungicidal mixtures, comprising as active components
(1) a benzamidoxime derivative of the formula I 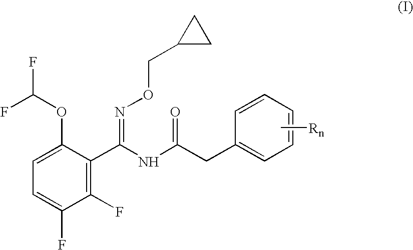 where the substituent and the index may have the following meanings:
R is hydrogen, halogen, C₁-C₄-alkyl, C₁-C₄-haloalkyl, C₁-C₄-alkoxy or C₁-C₄-haloalkoxy, n is 1, 2 or 3, and an azole derivative or a salt or adduct thereof, selected from the group consisting of
   (2) bromuconazole of the formula II 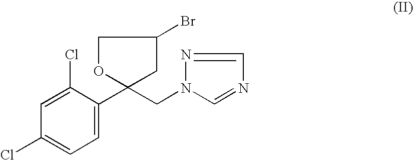 and
   (3) cyproconazole of the formula III 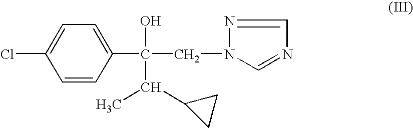 and
   (4) difenoconazole of the formula IV 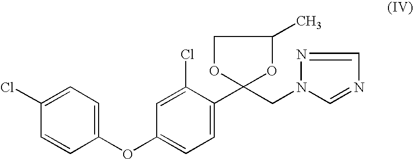 and
   (5) diniconazole of the formula V 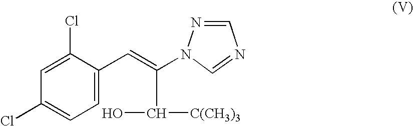 and
   (6) epoxiconazole of the formula VI 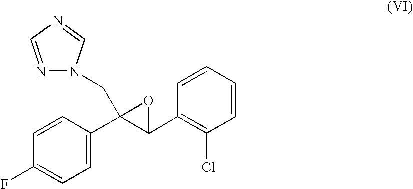 and
   (7) epoxiconazole of the formula VII 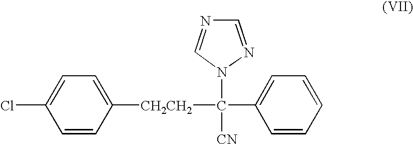 and
   (8) fenbuconazole of the formula VIII 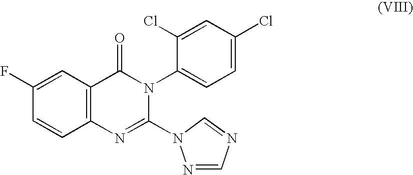 and
   (9) flusilazole of the formula IX 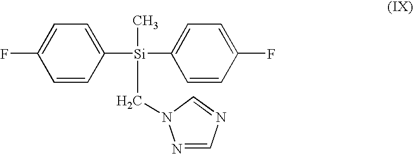 and
   (10) hexaconazole of the formula X 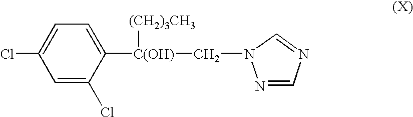 and
   (11) metconazole of the formula XI 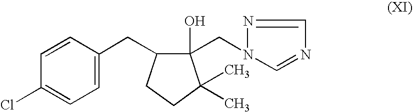 and
   (12) prochloraz of the formula XII 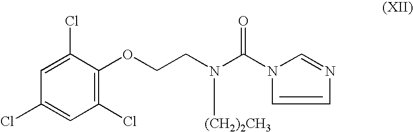 and
   (13) propiconazole of the formula XIII 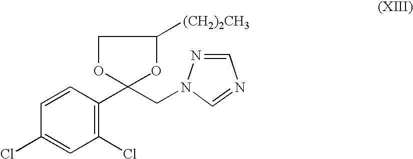 and
   (14) tebuconazole of the formula XIV 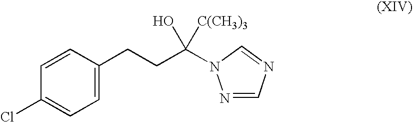 and
   (15) tetraconazole of the formula XV 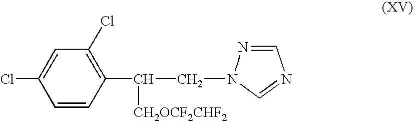 and
   (16) triflumizole of the formula XVI 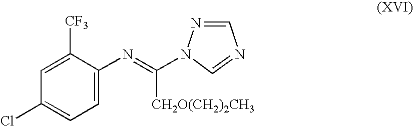 and
   (17) flutriafol of the formula XVII 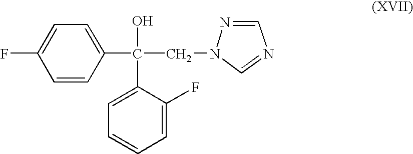 and
   (18) myclobutanil of the formula XVIII 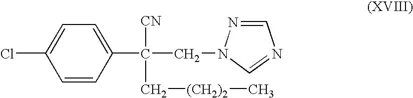 and
   (19) penconazole of the formula XIX 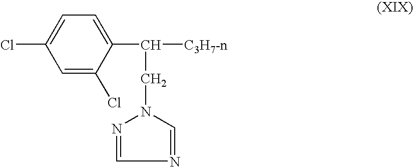 and
   (20) simeconazole of the formula XX 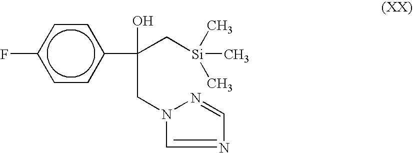 and
   (21) ipconazole of the formula XXI 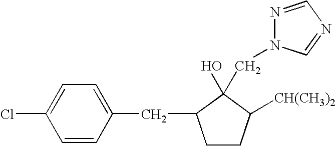 and
   (22) triticonazole of the formula XXII 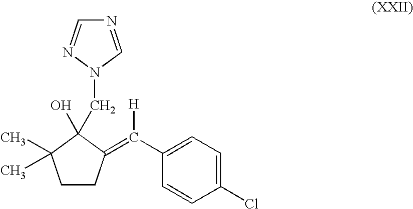 and
   (23) prothioconazole of the formula XXIII 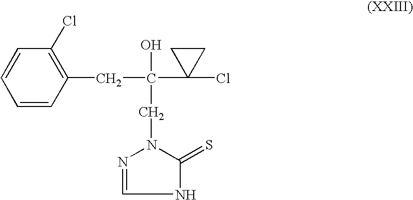 in a synergistically effective amount are described.

The present invention relates to fungicidal mixtures, comprising as active components
(1) a benzamidoxime derivative of the formula I 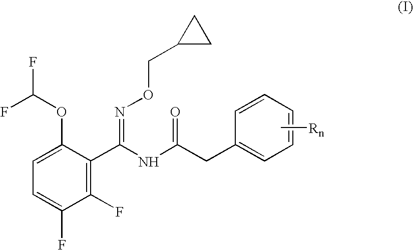
   where the substituent and the index may have the following meanings:
R is hydrogen, halogen, C₁-C₄-alkyl, C₁-C₄-haloalkyl, C₁-C₄-alkoxy or C₁-C₄-haloalkoxy,
n is 1, 2 or 3,
and an azole derivative or a salt or adduct thereof, selected from the group consisting of
(2) bromuconazole of the formula II 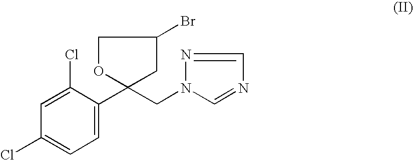
   and
(3) cyproconazole of the formula III 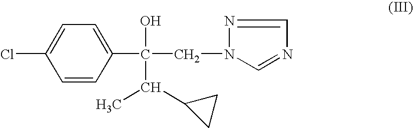
   and
(4) difenoconazole of the formula IV 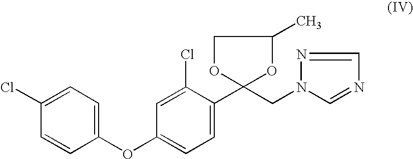
   and
(5) diniconazole of the formula V 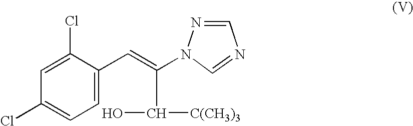
   and
(6) epoxiconazole of the formula VI 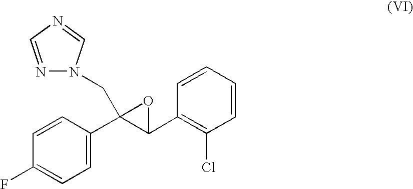
   and
(7) fenbuconazole of the formula VII 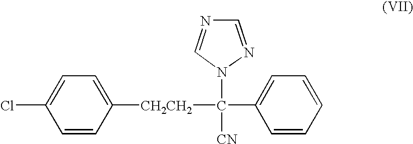
   and
(8) fluquinconazole of the formula VIII 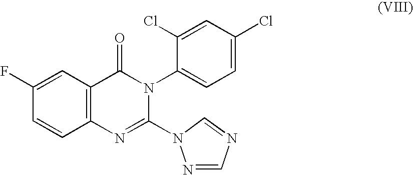
   and
(9) flusilazole of the formula IX 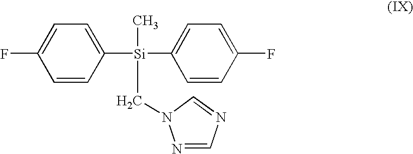
   and
(10) hexaconazole of the formula X 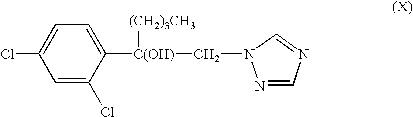
   and
(11) metconazole of the formula XI 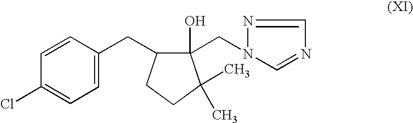
   and
(12) prochloraz of the formula XII 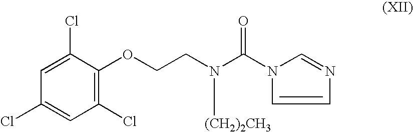
   and
(13) propiconazole of the formula XIII 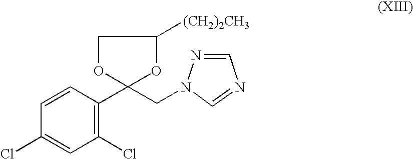
   and
(14) tebuconazole of the formula XIV 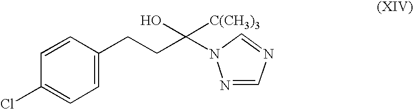
   and
(15) tetraconazole of the formula XV 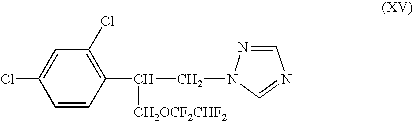
   and
(16) triflumizole of the formula XVI 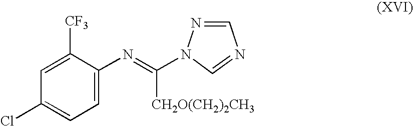
   and
(17) flutriafol of the formula XVII 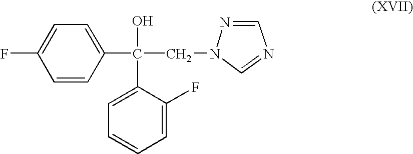
   and
(18) myclobutanil of the formula XVIII 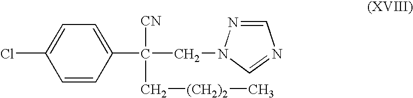
   and
(19) penconazole of the formula XIX 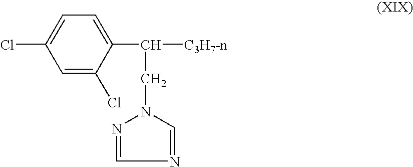
   and
(20) simeconazole of the formula XX 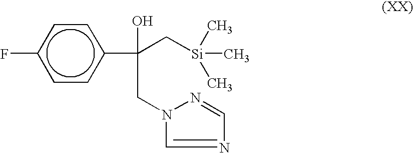
   and
   (21) ipconazole of the formula XXI 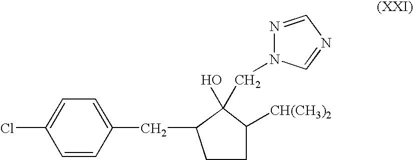
   and
(22) triticonazole of the formula XXII 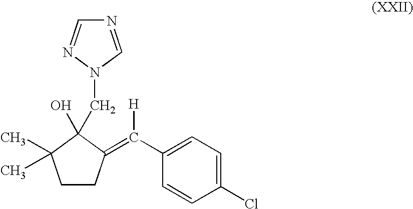
   and
(23) prothioconazole of the formula XXIII 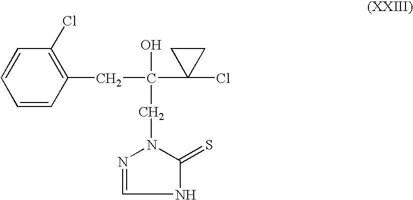
   in a synergistically effective amount.

Moreover, the invention relates to a method for controlling harmful fungi using mixtures of the compound I and at least one of the compounds II to XXIII and to the use of the compound I and at least one of the compounds II to XXIII for preparing such mixtures and to compositions comprising these mixtures.

Benzamidoxime derivatives of the formula I are known from EP-A-1017670.

EP-B 531,837, EP-A 645,091 and WO 97/06678 disclose fungicidal mixtures which comprise, as active compound component, one of the azoles II to XXIII.

The azole derivatives II to XXIII, their preparation and their action against harmful fungi are known per se:
bromuconazole (II): Proc. Br. Crop Prot. Conf.-Pests Dis., 5-6, 439 (1990);
cyproconazole (III): U.S. Pat. No. 4,664,696;
difenoconazole (IV): GB-A 2,098,607;
diniconazole (V): CAS RN [83657-24-3];
epoxiconazole (VI): EP-A 196 038;
fenbuconazole (VII): EP-A 251 775;
fluquinconazole (VIII): Proc. Br. Crop Prot. Conf.-Pests Dis., 5-3, 411 (1992);
flusilazole (IX): Proc. Br. Crop Prot. Conf.-Pests Dis., 1, 413 (1984);
hexaconazole (X): CAS RN [79983-71-4];
metconazole (XI): Proc. Br. Crop Prot. Conf.-Pests Dis., 5-4, 419 (1992);
prochloraz (XII): U.S. Pat. No. 3,991,071;
propiconazole (XIII): GB-A 1,522,657;
tebuconazole (IV): U.S. Pat. No. 4,723,984;
tetraconazole (XV): Proc. Br. Crop Prot. Conf.-Pests Dis., 1, 49 (1988);
triflumizole (XVI): JP-A 79/119,462
flutriafol (XVII): CAS RN [76674-21-0]
myclobutanil (XVIII): CAS RN [88671-89-0]
penconazole (XIX): Pesticide Manual, 12th Ed. (2000), page 712
simeconazole (XX): The BCPC Conference—Pests and Diseases 2000, pp. 557-562
ipconazole (XXI): EP-A-0 267 778
triticonazole (XXII): EP-A-0 378 953
prothioconazole (XXIII): WO 96/16048

It is an object of the present invention to provide further compositions for controlling harmful fungi and in particular for certain indications.

We have found that this object is achieved by a mixture which comprises, as active compounds, benzamidoxime derivatives of the formula I defined at the outset and, as further fungicidally active component, a fungicidally active compound from the class of the azoles II to XXIII.

The mixtures according to the invention act synergistically and are therefore particularly suitable for controlling harmful fungi and in particular powdery mildew fungi in cereals, vegetables and grapevines.

In the context of the present invention, halogen is fluorine, chlorine, bromine and iodine and in particular fluorine, chlorine and bromine.

The term “alkyl” embraces straight-chain or branched alkyl groups. These are preferably straight-chain or branched C₁-C₄-alkyl groups. Examples of alkyl groups are alkyl such as, in particular, methyl, ethyl, propyl, 1-methylethyl, butyl, 1-methylpropyl, 2-methylpropyl and 1,1-dimethylethyl.

Haloalkyl is an alkyl group as defined above which is partially 5 or fully halogenated by one or more halogen atoms, in particular by fluorine and chlorine. Preferably, 1 to 3 halogen atoms are present, and particular preference is given to the difluoromethane or the trifluoromethyl group.

What was mentioned above for the alkyl group and the haloalkyl group applies correspondingly to the alkyl and haloalkyl groups in alkoxy and haloalkoxy.

The radical R in the formula I is preferably a hydrogen atom.

Examples of compounds of the formula I are listed in Table 1.

TABLE 1

| | |
|---|---|
| | (I) |
| 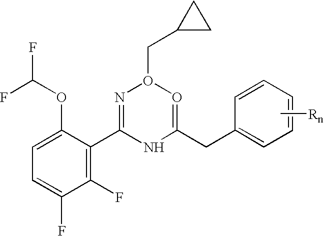 | |

| No. | R | n | m.p. ° C. |
|---|---|---|---|
| I.1 | H | 1 | 58-60 |
| I.2 | 4-F | 1 | 75-77 |
| I.3 | 4-Cl | 1 | 81-83 |
| I.4 | 4-OCH₃ | 1 | 57-59 |
| I.5 | 4-CF₃ | 1 | |

As azole derivative, the mixtures according to the invention comprise at least one compound of the formulae II to XXIII.

To unfold synergistic activity, even a small amount of benzamidoxime derivative of the formula I is sufficient. Benzamidoxime derivative and azole are preferably employed in a weight ratio in the range from 20:1 to 1:20, in particular 10:1 to 1:10.

Owing to the basic character of their nitrogen atoms, the azoles II-XXIII are capable of forming salts or adducts with inorganic or organic acids or with metal ions.

Examples of inorganic acids are hydrohalic acids, such as hydrogen fluoride, hydrogen chloride, hydrogen bromide and hydrogen iodide, sulfuric acid, phosphoric acid and nitric acid.

Suitable organic acids are, for example, formic acid, carbonic acid and alkanoic acids, such as acetic acid, trifluoroacetic acid, trichloroacetic acid and propionic acid, and also glycolic acid, thiocyanic acid, lactic acid, succinic acid, citric acid, benzoic acid, cinnamic acid, oxalic acid, alkylsulfonic acids (sulfonic acids having straight-chain or branched alkyl radicals of 1 to 20 carbon atoms), arylsulfonic acids or -disulfonic acids (aromatic radicals, such as phenyl and naphthyl, which carry one or two sulfo groups), alkylphosphonic acids (phosphonic acids having straight-chain or branched alkyl radicals of 1 to 20 carbon atoms), arylphosphonic acids or -diphosphonic acids (aromatic radicals, such as phenyl and naphthyl, which carry one or two phosphoric acid radicals), where the alkyl or aryl radicals may carry further substituents, for example p-toluenesulfonic acid, salicylic acid, p-aminosalicylic acid, 2-phenoxybenzoic acid, 2-acetoxybenzoic acid, etc.

Suitable metal ions are, in particular, the ions of the elements of the first to eighth transition group, in particular chromium, manganese, iron, cobalt, nickel, copper, zinc, and in addition those of the second main group, especially calcium and magnesium, and of the third and fourth main group, in particular aluminum, tin and lead. The metals can exist in the various valencies which they can assume.

Preference is given to mixtures of the benzamidoxime derivative of the formula I with bromuconazole.

Preference is given to mixtures of the benzamidoxime derivative of the formula I with cyproconazole.

Preference is given to mixtures of the benzamidoxime derivative of the formula I with difenoconazole.

Preference is given to mixtures of the benzamidoxime derivative of the formula I with diniconazole.

Preference is given to mixtures of the benzamidoxime derivative of the formula I with epoxiconazole.

Preference is given to mixtures of the benzamidoxime derivative of the formula I with fenbuconazole.

Preference is given to mixtures of the benzamidoxime derivative of the formula I with fluquinconazole.

Preference is given to mixtures of the benzamidoxime derivative of the formula I with flusilazole.

Preference is given to mixtures of the benzamidoxime derivative of the formula I with hexaconazole.

Preference is given to mixtures of the benzamidoxime derivative of the formula I with metconazole.

Preference is given to mixtures of the benzamidoxime derivative of the formula I with prochloraz.

Preference is given to mixtures of the benzamidoxime derivative of the formula I with propiconazole.

Preference is given to mixtures of the benzamidoxime derivative of the formula I with tebuconazole.

Preference is given to mixtures of the benzamidoxime derivative of the formula I with triflumizole.

Preference is given to mixtures of the benzamidoxime derivative of the formula I with flutriafol.

Preference is given to mixtures of the benzamidoxime derivative of the formula I with myclobutanil.

Preference is given to mixtures of the benzamidoxime derivative of the formula I with penconazole.

Preference is given to mixtures of the benzamidoxime derivative of the formula I with simeconazole.

Preference is given to mixtures of the benzamidoxime derivative of the formula I with ipconazole.

Preference is given to mixtures of the benzamidoxime derivative of the formula I with triticonazole.

Preference is given to mixtures of the benzamidoxime derivative of the formula I with prothioconazole.

When preparing the mixtures, it is preferred to employ the pure active compounds I to XXIII, to which further active compounds against harmful fungi or other pests, such as insects, arachnids or nematodes, or else herbicidal or growth-regulating active compounds or fertilizers can be admixed.

Mixtures of the compounds I and at least one of the compounds II to XXIII, or the compounds I and at least one of the compounds II to XXIII used simultaneously, jointly or separately, exhibit outstanding activity against a wide range of phytopathogenic fungi, in particular from the classes of the Ascomycetes, Basidiomycetes, Phycomycetes and Deuteromycetes. Some of them act systemically and can therefore also be employed as foliar- and soil-acting fungicides.

They are especially important for controlling a large number of fungi in a variety of crop plants, such as cotton, vegetable species (e.g. cucumbers, beans, tomatoes, potatoes and cucurbits), barley, grass, oats, bananas, coffee, corn, fruit species, rice, rye, soy, grapevine, wheat, ornamentals, sugar cane, and a variety of seeds.

They are particularly suitable for controlling the following phytopathogenic fungi: Blumeria graminis (powdery mildew) in cereals, Erysiphe cichoracearum and Sphaerotheca fuliginea in cucurbits, Podosphaera leucotricha in apples, Uncinula necator in grapevines, Puccinia species in cereals, Rhizoctonia species in cotton, rice and lawns, Ustilago species in cereals and sugar cane, Venturia inaequalis (scab) in apples, Helminthosporium species in cereals, Septoria nodorum in wheat, Botrytis cinera (gray mold) in strawberries, vegetables, ornamentals and grapevines, Cercospora arachidicola in groundnuts, Pseudocercosporella herpotrichoides in wheat and barley, Pyricularia oryzae in rice, Phytophthora infestans in potatoes and tomatoes, Plasmopara viticola in grapevines, Pseudoperonospora species in hops and cucumbers, Alternaria species in vegetables and fruit, Mycosphaerella species in bananas and Fusarium and Verticillium species.

The mixtures according to the invention may particularly preferably be employed for controlling powdery mildew fungi in crops of cereals, vegetables and grapevines, and also in ornamentals.

The compound I and at least one of the compounds II to XXIII can be applied simultaneously, either together or separately, or successively, the sequence, in the case of separate application, generally not having any effect on the result of the control measures.

Depending on the kind of effect desired, the application rates of the mixtures according to the invention are, in particular in agricultural crop areas, from 0.01 to 8 kg/ha, preferably 0.1 to 5 kg/ha, in particular 0.5 to 3.0 kg/ha.

The application rates of the compounds I are from 0.01 to 2.5 kg/ha, preferably 0.05 to 2.5 kg/ha, in particular 0.1 to 1.0 kg/ha.

Correspondingly, in the case of the compounds II to XXIII, the application rates are from 0.01 to 10 kg/ha, preferably 0.05 to 5 kg/ha, in particular 0.05 to 2.0 kg/ha.

For seed treatment, the application rates of the mixture are generally from 0.001 to 250 g/kg of seed, preferably 0.01 to 100 g/kg, in particular 0.01 to 50 g/kg.

If phytopathogenic harmful fungi are to be controlled, the separate or joint application of the compounds I and at least one of the compounds II to XXIII or of the mixtures of the compounds I and at least one of the compounds II to XXIII is effected by spraying or dusting the seeds, the plants or the soils before or after sowing of the plants, or before or after plant emergence.

The fungicidal synergistic mixtures according to the invention, or the compound I and at least one of the compounds II to XXIII, can be formulated for example in the form of ready-to-spray solutions, powders and suspensions or in the form of highly concentrated aqueous, oily or other suspensions, dispersions, emulsions, oil dispersions, pastes, dusts, materials for broadcasting or granules, and applied by spraying, atomizing, dusting, broadcasting or watering. The use form depends on the intended purpose; in any case, it should ensure as fine and uniform as possible a distribution of the mixture according to the invention.

The formulations are prepared in a known manner, e.g. by extending the active compound with solvents and/or carriers, if desired using emulsifiers and dispersants, it being possible also to use other organic solvents as auxiliary solvents if water is used as the diluent. Suitable auxiliaries for this purpose are essentially: solvents such as aromatics (e.g. xylene), chlorinated aromatics (e.g. chlorobenzenes), paraffins (e.g. mineral oil fractions), alcohols (e.g. methanol, butanol), ketones (e.g. cyclohexanone), amines (e.g. ethanolamine, dimethylformamide) and water; carriers such as ground natural minerals (e.g. kaolins, clays, talc, chalk) and ground synthetic minerals (e.g. finely divided silica, silicates); emulsifiers such as nonionic and anionic emulsifiers (e.g. polyoxyethylene fatty alcohol ethers, alkylsulfonates and arylsulfonates) and dispersants such as lignosulfite waste liquors and methylcellulose.

Suitable surfactants are the alkali metal salts, alkaline earth metal salts and ammonium salts of aromatic sulfonic acids, e.g. ligno-, phenol-, naphthalene- and dibutylnaphthalenesulfonic acid, and of fatty acids, alkyl- and alkylarylsulfonates, alkyl, lauryl ether and fatty alcohol sulfates, and salts of sulfated hexa-, hepta- and octadecanols, or of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl- or nonylphenol, alkylphenol polyglycol ethers, tributylphenyl polyglycol ethers, alkylaryl polyether alcohols, isotridecyl alcohol, fatty alcohol/ethylene oxide condensates, ethoxylated castor oil, polyoxyethylene alkyl ethers or polyoxypropylene [lacuna], lauryl alcohol polyglycol ether acetate, sorbitol esters, lignosulfite waste liquors or methylcellulose.

Powders, materials for broadcasting and dusts can be prepared by mixing or jointly grinding the compounds I or II to XXIII, or the mixture of the compounds I and at least one of the compounds II to XXIII, with a solid carrier.

Granules (e.g. coated granules, impregnated granules or homogeneous granules) are usually prepared by binding the active compound, or active compounds, to a solid carrier.

Fillers or solid carriers are, for example, mineral earths, such as silicas, silica gels, silicates, talc, kaolin, limestone, lime, chalk, bole, loess, clay, dolomite, diatomaceous earth, calcium sulfate, magnesium sulfate, magnesium oxide, ground synthetic materials and fertilizers, such as ammonium sulfate, ammonium phosphate, ammonium nitrate, ureas, and products of vegetable origin, such as cereal meal, tree bark meal, wood meal and nutshell meal, cellulose powders or other solid carriers.

The formulations generally comprise from 0.1 to 95% by weight, preferably 0.5 to 90% by weight, of one of the compounds I or II to XXIII or of the mixture of the compounds I and at least one of the compounds II to XXIII. The active compounds are employed in a purity of from 90% to 100%, preferably 95% to 100% (according to NMR spectrum or HPLC).

The compounds I and II to XXIII, the mixtures, or the corresponding formulations, are applied by treating the harmful fungi, their habitat, or the plants, seeds, soils, areas, materials or spaces to be kept free from them with a fungicidally effective amount of the mixture, or of the compounds I and at least one of the compounds II to XXIII in the case of separate application.

Application can be effected before or after infection by the harmful fungi.

Examples of such preparations comprising the active compounds are:
I. a solution of 90 parts by weight of the active compounds and 10 parts by weight of N-methylpyrrolidone; this solution is suitable for use in the form of microdrops;
II. a mixture of 20 parts by weight of the active compounds, 80 parts by weight of xylene, 10 parts by weight of the adduct of 8 to 10 mol of ethylene oxide to 1 mol of oleic acid N-monoethanolamide, 5 parts by weight of the calcium salt of dodecylbenzenesulfonate, 5 parts by weight of the adduct of 40 mol of ethylene oxide and 1 mol of castor oil; a dispersion is obtained by finely distributing the solution in water;
III. an aqueous dispersion of 20 parts by weight of the active compounds, 40 parts by weight of cyclohexanone, 30 parts by weight of isobutanol, 20 parts by weight of the adduct of 40 mol of ethylene oxide and 1 mol of castor oil;
IV. an aqueous dispersion of 20 parts by weight of the active compounds, 25 parts by weight of cyclohexanol, 65 parts by weight of a mineral oil fraction of boiling point 210 to 280° C., and 10 parts by weight of the adduct of 40 mol of ethylene oxide and 1 mol of castor oil;
V. a mixture, ground in a hammer mill, of 80 parts by weight of the active compounds, 3 parts by weight of the sodium salt of diisobutylnaphthalene-1-sulfonate, 10 parts by weight of the sodium salt of a lignosulfonic acid from a sulfite waste liquor and 7 parts by weight of pulverulent silica gel; a spray mixture is obtained by finely distributing the mixture in water;
VI. an intimate mixture of 3 parts by weight of the active compounds and 97 parts by weight of finely divided kaolin; this dust comprises 3% by weight of active compound;
VII. an intimate mixture of 30 parts by weight of the active compounds, 92 parts by weight of pulverulent silica gel and 8 parts by weight of paraffin oil which had been sprayed onto the surface of this silica gel; this formulation imparts good adhesion to the active compound;

VIII. a stable aqueous dispersion of 40 parts by weight of the active compounds, 10 parts by weight of the sodium salt of a phenolsulfonic acid/urea/formaldehyde condensate, 2 parts by weight of silica gel and 48 parts by weight of water; this dispersion may be diluted further;
IX. a stable oily dispersion of 20 parts by weight of the active compounds, 2 parts by weight of the calcium salt of dodecylbenzenesulfonate, 8 parts by weight of fatty alcohol polyglycol ether, 20 parts by weight of the sodium salt of a phenolsulfonic acid/urea/formaldehyde condensate and 88 parts by weight of a paraffinic mineral oil.

### USE EXAMPLE

The synergistic activity of the mixtures according to the invention can be demonstrated by the following experiments:

The active compounds, separately or together, are formulated as a 10% emulsion in a mixture of 63% by weight of cyclohexanone and 27% by weight of emulsifier, and diluted with water to the desired concentration.

Evaluation is carried out by determining the infected leaf areas as a percentage. These percentages are converted into efficacies. The efficacy (W) is calculated as follows using Abbot's formula:

$$W = ( 1 - \frac{α}{β} ) \cdot 100$$

α corresponds to the fungal infection of the treated plants as a % and
β corresponds to the fungal infection of the untreated (control) plants as a %

An efficacy of 0 means that the infection level of the treated plants corresponds to that of the untreated control plants; an efficacy of 100 means that the treated plants were not infected.

The expected efficacies of the mixtures of the active compounds were determined using Colby's formula [R. S. Colby, Weeds 15, 20-22 (1967)] and compared with the observed efficacies.
Colby's formula: E=x+y−x·y/100
E expected efficacy, expressed as a % of the untreated control, when using the mixture of the active compounds A and B at the concentrations a and b
x efficacy, expressed as a % of the untreated control, when using active compound A at a concentration of a
y efficacy, expressed as a % of the untreated control, when using active compound B at a concentration of b

### Use Example 1

### Activity Against Mildew of Wheat Caused by Erysiphe [syn. Blumeria] graminis forma specialis. tritici

Leaves of wheat seedlings of the cultivar “Kanzler”, grown in pots, were sprayed to runoff point with an aqueous preparation of active compound which had been prepared from a stock solution comprising 10% of active compound, 85% of cyclohexanone and 5% of emulsifier, and 24 hours after the spray coating had dried on the leaves were dusted with spores of mildew of wheat (Erysiphe [syn. Blumeria] graminis forma specialis. tritici). The test plants were then placed in a greenhouse at 20-24° C. and 60-90% relative atmospheric humidity. After 7 days, the extent of the mildew development was determined visually in % infection of the entire leaf area.

The visually determined values for the percentage of diseased leaf areas were converted into efficacies in % of the untreated control. An efficacy of 0 means the same disease level in the untreated control, an efficacy of 100 means a disease level of 0%. The expected efficacies for the combinations of active compounds were determined using Colby's formula (Colby, S. R. (Calculating synergistic and antagonistic responses of herbicide Combinations”, Weeds, 15, pp. 20-22, 1967) and compared with the observed efficacies.

TABLE 2

| | Concentration of active | Efficacy in % of |
|---|---|---|
| | compound in the spray | the untreated |
| Active compound | liquor in ppm | control |
| Control (untreated) | (99% infection) | 0 |
| Compound I = I.1 | 0.25 | 29 |
| | 0.06 | 0 |
| | 0.015 | 0 |
| | 0.004 | 0 |
| Compound VI = | 1 | 59 |
| epoxiconazole | 0.25 | 29 |
| | 0.125 | 0 |
| | 0.06 | 0 |
| | 0.015 | 0 |
| Compound XI = | 0.25 | 0 |
| metconazole | 0.06 | 0 |
| | 0.015 | 0 |
| Compound XVIII = | 0.25 | 0 |
| myclobutanil | 0.06 | 0 |
| | 0.015 | 0 |

TABLE 3

| | Observed | Calculated |
|---|---|---|
| Combinations claimed | efficacy | efficacy*) |
| Compound I = I.1 + Compound | 39 | 29 |
| VI = epoxiconazole | | |
| 0.015 + 0.25 ppm | | |
| Mixture 1:16 | | |
| Compound I = I.1 + Compound | 19 | 0 |
| VI = epoxiconazole | | |
| 0.004 + 0.06 ppm | | |
| Mixture 1:16 | | |
| Compound I = I.1 + Compound | 95 | 84 |
| VI = epoxiconazole | | |
| 0.25 + 1 ppm | | |
| Mixture 1:4 | | |
| Compound I = I.1 + Compound | 70 | 50 |
| VI = epoxiconazole | | |
| 0.06 + 0.25 ppm | | |
| Mixture 1:4 | | |
| Compound I = I.1 + Compound | 95 | 59 |
| VI = epoxiconazole | | |
| 0.25 + 0.06 ppm | | |
| Mixture 4:1 | | |
| Compound I = I.1 + Compound | 70 | 59 |
| VI = epoxiconazole | | |
| 0.25 + 0.015 ppm | | |
| Mixture 16:1 | | |
| Compound I = I.1 + Compound | 19 | 0 |
| XI = metconazole | | |
| 0.004 + 0.06 ppm | | |
| Mixture 1:16 | | |
| Compound I = I.1 + Compound | 39 | 29 |
| XI = metconazole | | |
| 0.06 + 0.25 ppm | | |
| Mixture 1:4 | | |
| Compound I = I.1 + Compound | 95 | 59 |
| XI = metconazole | | |
| 0.25 + 0.06 ppm | | |
| Mixture 4:1 | | |
| Compound I = I.1 + Compound | 70 | 59 |
| XI = metconazole | | |
| 0.25 + 0.015 ppm | | |
| Mixture 16:1 | | |
| Compound I = I.1 + Compound | 19 | 0 |
| XVIII = myclobutanil | | |
| 0.004 + 0.06 ppm | | |
| Mixture 1:16 | | |
| Compound I = I.1 + Compound | 39 | 29 |
| XVIII = myclobutanil | | |
| 0.06 + 0.25 ppm | | |
| Mixture 1:4 | | |
| Compound I = I.1 + Compound | 79 | 59 |
| XVIII = myclobutanil | | |
| 0.25 + 0.06 ppm | | |
| Mixture 4:1 | | |
| Compound I = I.1 + Compound | 93 | 59 |
| XVIII = myclobutanil | | |
| 0.25 + 0.015 ppm | | |
| Mixture 16:1 | | |

*)efficacy calculated using Colby's formula

The test results show that in all mixing ratios the observed efficacy is higher than the efficacy calculated beforehand using Colby's formula (from Synerg 174. XLS).

### Use Example 2

### Curative Activity Against Brown Rust of Wheat Caused by Puccinia recondita

Leaves of wheat seedlings of the cultivar “Kanzler”, grown in pots, were dusted with spores of brown rust (Puccinia recondita). The pots were then placed in a chamber with high atmospheric humidity (90-95%), at 20-22° C., for 24 hours. During this time the spores germinated and the germinal tubes penetrated into the leaf tissue. The next day, the infected plants were sprayed to runoff point with an aqueous formulation of active compound prepared from a stock solution consisting of 10% of active compound, 85% of cyclohexanone and 5% of emulsifier. After the spray coating had dried on, the test plants were cultivated in a greenhouse at 20-22° C. and 65-70% relative atmospheric humidity for 7 days. Thereafter, the extent of the rust fungus development on the leaves was determined.

The visually determined values for the percentage of diseased leaf areas were converted into efficacies in % of the untreated control. An efficacy of 0 means the same disease level as in the untreated control, an efficacy of 100 means a disease level of 0%. The expected efficacies for the combinations of active compounds were determined using Colby's formula (Colby. S. R. (Calculating synergistic and antagonistic responses of herbicide Combinations”, Weeds, 15, pp. 20-22, 1967) and compared with the observed efficacies.

TABLE 4

| | Concentration of active | Efficacy in % of |
|---|---|---|
| | compound in the spray | the untreated |
| Active compound | liquor in ppm | control |
| Control | (99% infection) | 0 |
| (untreated) | | |
| Compound I = I.1 | 1 | 0 |
| | 0.25 | 0 |
| | 0.06 | 0 |
| | 0.015 | 0 |
| | 0.004 | 0 |
| Compound VI = | 0.25 | 56 |
| epoxiconazole | 0.06 | 11 |
| | 0.015 | 0 |
| Compound XI = | 0.25 | 56 |
| metconazole | 0.06 | 0 |
| | 0.015 | 0 |
| Compound XVIII = | 1 | 0 |
| myclobutanil | 0.25 | 0 |
| | 0.06 | 0 |

TABLE 5

| | Observed | Calculated |
|---|---|---|
| Combinations claimed | efficacy | efficacy*) |
| Compound I = I.1 + Compound | 100 | 56 |
| VI = epoxiconazole | | |
| 0.015 + 0.25 ppm | | |
| Mixture 1:16 | | |
| Compound I = I.1 + Compound | 33 | 11 |
| VI = epoxiconazole | | |
| 0.004 + 0.06 ppm | | |
| Mixture 1:16 | | |
| Compound I = I.1 + Compound | 67 | 56 |
| VI = epoxiconazole | | |
| 0.06 + 0.25 ppm | | |
| Mixture 1:4 | | |
| Compound I = I.1 + Compound | 11 | 0 |
| VI = epoxiconazole | | |
| 0.06 + 0.015 ppm | | |
| Mixture 4:1 | | |
| Compound I = I.1 + Compound | 22 | 0 |
| VI = epoxiconazole | | |
| 0.25 + 0.015 ppm | | |
| Mixture 16:1 | | |
| Compound I = I.1 + Compound | 22 | 0 |
| XI = metconazole | | |
| 0.004 + 0.06 ppm | | |
| Mixture 1:16 | | |
| Compound I = I.1 + Compound | 67 | 56 |
| XI = metconazole | | |
| 0.06 + 0.25 ppm | | |
| Mixture 1:4 | | |
| Compound I = I.1 + Compound | 22 | 0 |
| XI = metconazole | | |
| 0.25 + 0.06 ppm | | |
| Mixture 4:1 | | |
| Compound I = I.1 + Compound | 11 | 0 |
| XI = metconazole | | |
| 0.25 + 0.015 ppm | | |
| Mixture 16:1 | | |
| Compound I = I.1 + Compound | 22 | 0 |
| XVIII = myclobutanil | | |
| 0.06 + 1 ppm | | |
| Mixture 1:16 | | |
| Compound I = I.1 + Compound | 56 | 0 |
| XVIII = myclobutanil | | |
| 0.25 + 1 ppm | | |
| Mixture 1:4 | | |
| Compound I = I.1 + Compound | 33 | 0 |
| XVIII = myclobutanil | | |
| 1 + 0.25 ppm | | |
| Mixture 4:1 | | |
| Compound I = I.1 + Compound | 22 | 0 |
| XVIII = myclobutanil | | |
| 1 + 0.06 ppm | | |
| Mixture 16:1 | | |

*)efficacy calculated using Colby's formula

The test results show that in all mixing ratios the observed efficacy is higher than the efficacy calculated beforehand using Colby's formula (from Synerg 174. XLS).

1. A fungicidal mixture, comprising as active components
(1) a benzamidoxime derivative of the formula I 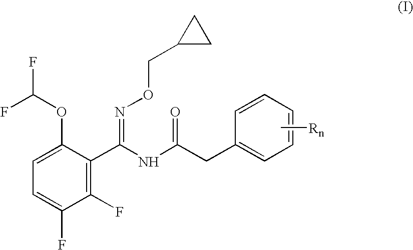
where the substituent and the index may have the following meanings:
R is hydrogen, halogen, C₁-C₄-alkyl, C₁-C₄-haloalkyl, C₁-C₄-alkoxy or C₁-C₄-haloalkoxy,
n is 1, 2 or 3,
and an azole derivative or a salt or adduct thereof, selected from the group consisting of
(2) bromuconazole of the formula II 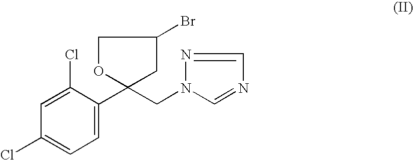
and
(3) cyproconazole of the formula Ill 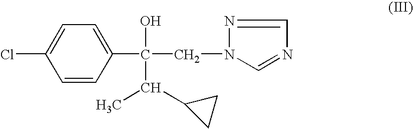
and
(4) difenoconazole of the formula IV 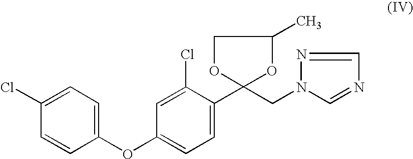
and (5) diniconazole of the formula V 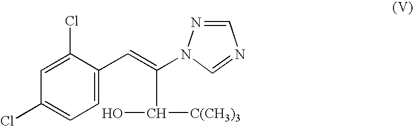
and
(6) epoxiconazole of the formula VI 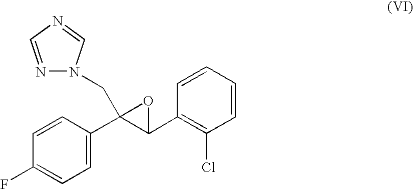
and (7) fenbuconazole of the formula VII 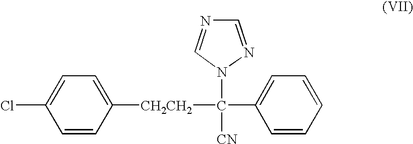
and
(8) fluquinconazole of the formula VIII 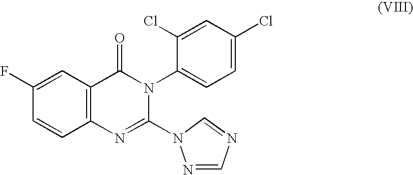
and
(9) flusilazole of the formula IX 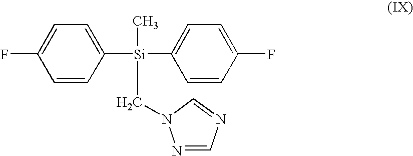
and
(10) hexaconazole of the formula X 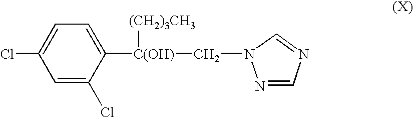
and
(11) metconazole of the formula XI 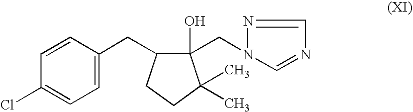
and
(12) prochloraz of the formula XII 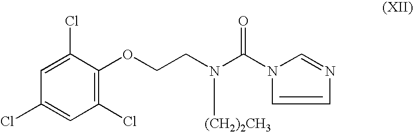
and
(13) propiconazole of the formula XIII 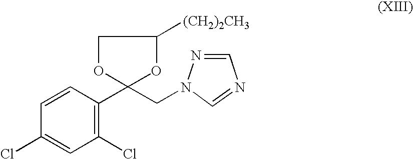
and
(14) tebuconazole of the formula XIV 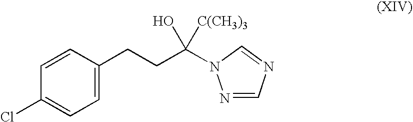
and
(15) tetraconazole of the formula XV 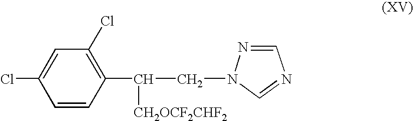
and
(16) triflumizole of the formula XVI 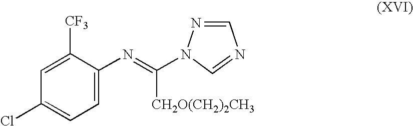
and
(17) flutriafol of the formula XVII 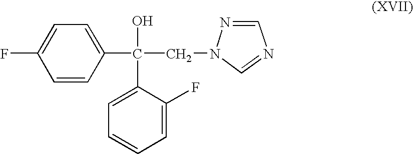
and
(18) myclobutanil of the formula XVIII 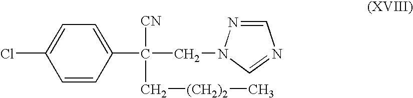
and
(19) penconazole of the formula XIX 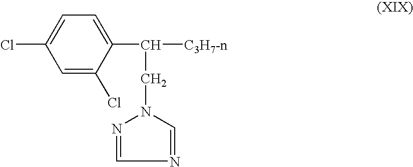
and
(20) simeconazole of the formula XX 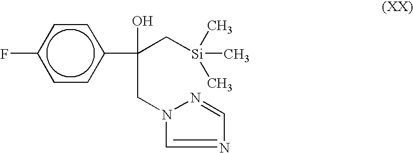
and
(21) ipconazole of the formula XXI 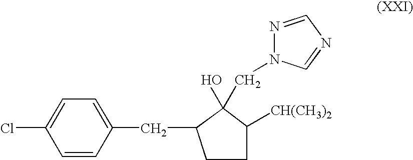
and
(22) triticonazole of the formula XXII 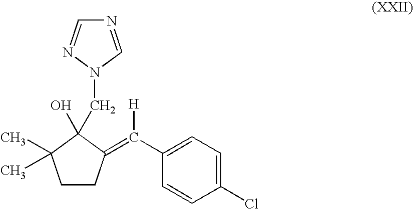
and
(23) prothioconazole of the formula XXIII 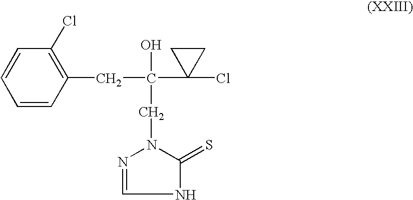
in a synergistically effective amount.

2. A fungicidal mixture as claimed in claim 1 where in formula I the radical R is hydrogen.

3. A fungicidal mixture as claimed in claim 1, wherein the weight ratio of the benzamidoxime derivative of the formula I to the triazole of the formulae II to XXIII in question is from 20:1 to 1:20.

4. A method for controlling harmful fungi, which comprises treating the harmful fungi, their habitat or the plants, seeds, soils, areas, materials or spaces to be kept free from them with a fungicidal mixture as claimed in claim 1.

5. A method as claimed in claim 4, wherein the compound of the formula I and at least one compound of the formulae II to XXIII are applied simultaneously, i.e. together or separately, or successively.

6. A method as claimed in claim 4, wherein the fungicidal mixture or the compound of the formula I and at least one compound of the formulae II to XXIII are applied in an amount of from 0.01 to 8 kg/ha.

7. A fungicidal composition, comprising the fungicidal mixture as claimed in claim 1 and a solid or liquid carrier.
